(19) United States
(12) Patent Application Publication
(10) Pub. No.: US 2026/0110352 A1
(43) Pub. Date: Apr. 23, 2026

(54) DIFFERENTIAL UNIT

(71) Applicant: TOYOTA JIDOSHA KABUSHIKI KAISHA, Toyota-shi (JP)

(72) Inventor: Kengo OKUMOTO, Seto-shi (JP)

(73) Assignee: TOYOTA JIDOSHA KABUSHIKI KAISHA, Toyota-shi (JP)

(21) Appl. No.: 19/362,265

(22) Filed: Oct. 17, 2025

(30) Foreign Application Priority Data
Oct. 18, 2024 (JP) 2024-184450

(51) Int. Cl. F16H 48/40; F16H 48/08; F16H 57/00

(52) U.S. Cl. CPC F16H 48/40; F16H 48/08; F16H 57/0006; F16H 2048/087

(57) ABSTRACT

A differential unit configured to reduce noise of a ring gear by preventing rotational runout of a differential case. The differential unit comprises: a ring gear formed on the differential case; side gears held in the differential case while being opposed to each other; pinion gears interposed between the side gears; and a pinion shaft rotatably supporting the pinion gears. End sections of the pinion shaft are press-fitted into through holes of the differential case, and a diameter of an overhang portion of the pinion shaft located outside of the through hole is larger than an inner diameter of the through hole.

### CROSS-REFERENCE TO RELATED APPLICATIONS

The present disclosure claims the benefit of Japanese Patent Application No. 2024-184450 filed on October 18, 2024 with the Japanese Patent Office, the disclosures of which are incorporated herein by reference in its entirety.

### BACKGROUND

### Field of the Disclosure

The embodiment of the present disclosure relates to the art of a differential unit in which a pair of side gears are allowed to rotate in a differential manner by rotations of pinion gears meshing therewith.

### Discussion of the Related Art

One example of the differential unit of this kind is disclosed in JP-A-2010-031913. A differential device according to JP-A-2010-031913 comprises a differential case integrated with a ring gear, and a pair of side gears arranged in the differential case while being opposed to each other on a rotational center axis of the differential case. In addition, a pair of pinion gears are interposed between the side gears while meshing therewith. Specifically, the pinion gears are rotatably supported by a pinion shaft extending perpendicular to a rotational center axis of the differential case, and the pinion shaft is press-fitted into a shaft hole formed on the differential case and fixed to the differential case.

In the differential device described in JP-A-2010-031913, the pinion shaft is in close contact with the differential case to be integrated therewith. Therefore, the rigidity of the differential case itself, and the support rigidity of the differential case supporting the pinion shaft are ensured. For these reasons, a transmission error between the pinion gear and the side gear may be reduced so that noises and vibrations generated by those gears may be reduced. However, since torque is delivered to the differential case from the ring gear integrated therewith, gear noise may be emitted depending on the engagement condition of the ring gear. Specifically, the differential case is supported by a vehicle body through a bearing, but the ring gear is meshed with the drive pinion at a site away from a site where the differential case is supported by the bearing. Therefore, the differential case and the rotation of the differential case may be distorted slightly by the torque applied to the ring gear. Such distortion of rotation is referred to as a rotational runout which may cause a transmission error of the ring gear, and gear noise may be emitted due to the transmission error of the ring gear. The gear noise caused by such rotational runout may not be reduced by the differential device described in JP-A-2010-031913, and hence the conventional differential devices have to be improved to reduce the gear noise.

### SUMMARY

The embodiment of the present disclosure has been conceived noting the foregoing technical problems, and it is therefore an object of the present disclosure to improve a rigidity of the differential case and a support stiffness of the differential case to support the pinion shaft, and to reduce gear noise of the ring gear by preventing rotational runout of the differential case.

According to the exemplary embodiment the present disclosure, there is provided a differential unit, comprising: a differential case in which a ring gear is formed integrally on its outer circumferential surface; a pair of side gears held in the differential case while being opposed to each other to rotate on a rotational center axis of the differential case; a pair of pinion gears interposed between the side gears while being meshed with the side gears; and a pinion shaft penetrating through the pinion gears in a direction perpendicular to the rotational center axis of the differential case so as to support the pinion gears in a rotatable manner. In the differential unit, both end sections of the pinion shaft are supported by the differential case. In order to achieve the above-explained objective, according to the exemplary embodiment of the present disclosure, the differential case comprises a through hole into which the end section of the pinion shaft is inserted, and the end section of the pinion shaft is press-fitted into the through hole of the differential case. In addition, the pinion shaft comprises an overhang portion located outside of the through hole of the differential case, and a diameter of the overhang portion is larger than an inner diameter of the through hole.

In a non-limiting embodiment, one of the end sections of the pinion shaft may include a plug member having a hollow cylindrical shape that is formed integrally with the overhang portion. The pinion shaft may be fitted into a hollow space of the plug member, and the plug member may be press-fitted into the through hole.

In a non-limiting embodiment, the through hole and the end section press-fitted into the trough hole may have a circular cross-section.

In a non-limiting embodiment, the overhang portion of the plug member may comprise an engagement portion that is engaged with a tool for extracting the plug member from the through hole.

Thus, in the differential unit according to the exemplary embodiment of the present disclosure, the pinion shaft is press-fitted into the through hole of the differential case to be integrated with the differential case. According to the exemplary embodiment of the present disclosure, therefore, a rigidity of the differential case and a support stiffness of the differential case to support the pinion shaft may be improved. For this reason, a transmission error between the pinion gear and the side gear may be reduced. Consequently, any gear noise associated with such transmission error may also be reduced. In addition, an inertial mass or an inertial moment of the differential case is increased by the overhang portion formed on the end section of the pinion shaft. According to the exemplary embodiment of the present disclosure, therefore, a rotational runout of the differential case may be prevented so that the gear noise of the ring gear integrated with the differential case may be reduced. Further, since the diameter of the overhang portion is larger than the inner diameter of the through hole, a deformation of the end section of the pinion shaft may be prevented even when a load is applied to the overhang portion to fit the pinion shaft into the through hole.

Moreover, since the plug member having the overhang portion is attached to one of the end sections of the pinion shaft, the differential unit may be assembled easily. In order to assemble the differential unit, specifically, one of the end sections of the pinion shaft on which the plug member has not yet been mounted is press-fitted into one of the through holes. Thereafter, one of the end sections of the pinion shaft is press-fitted into the other one of the through holes, and the plug member is fitted onto one of the end sections of the pinion shaft.

Furthermore, in the differential case according to the exemplary embodiment of the present disclosure, the through hole and the end section of the pinion shaft have a circular cross-section. Therefore, a wide pressure receiving area may be ensured between the through hole and the end section of the pinion shaft, and this prevents the through hole and the end section of the pinion shaft from wearing due to repeated loading.

In addition, in the differential case according to the exemplary embodiment of the present disclosure, the engagement portion is formed on the overhang portion of the plug member. Therefore, a pulling force may be applied easily to the plug member to extract the plug member from the through hole by engaging the tool with the engagement portion. For this reason, the differential unit may be assembled and disassembled easily.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a cross-sectional view showing a structure of the differential unit according to the exemplary embodiment of the present disclosure;

FIG. 2 is a partially omitted exploded view showing a structure of the pinion shaft; and

FIG. 3 is a cross-sectional view schematically showing a through hole of the differential case.

### DETAILED DESCRIPTION OF THE PREFERRED EMBODIMENTS

An embodiment of the present disclosure will now be explained with reference to the accompanying drawings. Note that the embodiments shown below are merely examples of the present disclosure, and do not limit the present disclosure.

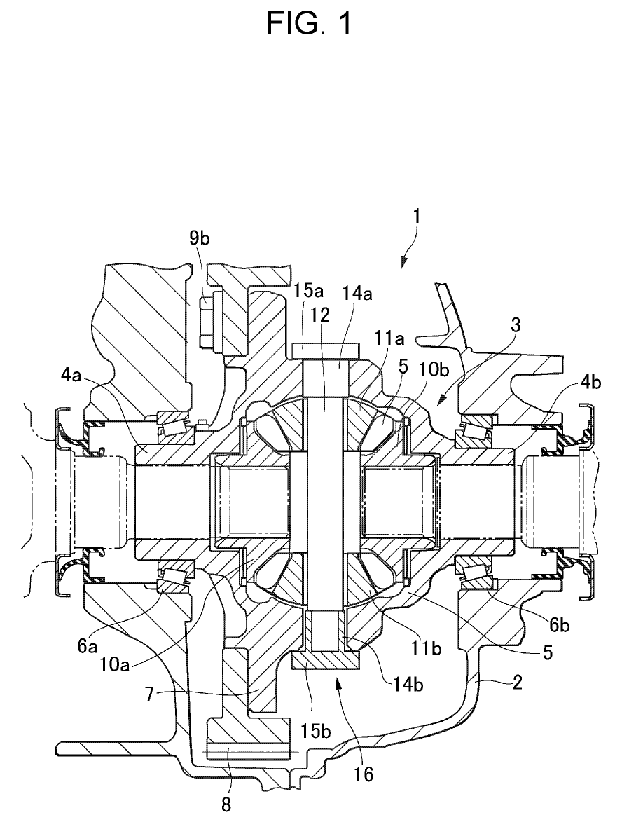

A structure of the differential unit according to the exemplary embodiment of the present disclosure is similar to that of the conventional differential gear units except for a structure of the pinion shaft and a structure of attaching the pinion shaft to a differential case. Referring now to FIG. 1, there is shown one example of a structure of the differential unit 1 according to the exemplary embodiment of the present disclosure. As illustrated in FIG. 1, the differential unit 1 is housed in a differential carrier 2, and a differential case 3 of the differential unit 1 is supported by the differential carrier 2 in a rotatable manner. The differential case 3 comprises a boss 4a and a boss 4b extending coaxially on both sides of the differential case 3, and a frame section (or a support plate section) 5 connecting the bosses 4a and 4b. Specifically, the differential case 3 is supported by the differential carrier 2 through a bearing 6a fitted onto the boss 4a and a bearing 6b fitted onto the boss 4b. A flange 7 is formed on an outer circumferential surface of the frame section 5 at a site close to one of the bosses 4a and 4b, and a ring gear 8 is fixed to the flange 7 by a bolt 9 to be integrated with the differential case 3.

In the frame section 5, a pair of side gears 10a and 10b are opposed to each other coaxially with the bosses 4a and 4b. Each of the side gears 10a and 10b has a hollow space formed coaxially with the bosses 4a and 4b, and rotary shafts (not shown) are splined into the hollow spaces of the side gears 10a and 10b. Specifically, the side gears 10a and 10b are bevel gears, and a pair of pinion gears 11a and 11b are interposed between the side gears 10a and 10b while being meshed with the side gears 10a and 10b. The pinion gears 11a and 11b are fitted onto the pinion shaft 12 in a rotatable manner to be connected to the differential case 3 through the pinion shaft 12.

Specifically, the pinion shaft 12 is disposed between the side gears 10a and 10b to extend perpendicular to a common center axis of the bosses 4a and 4b as a rotational center axis of the differential case 3. That is, the pinion shaft 12 extends between the opposing frame sections 5 of the differential case 3, and each end of the pinion shaft 12 is fixed to the frame section 5. As described, the pinion gears 11a and 11b are rotatably fitted onto the pinion shaft 12 in the differential case 3, that is, the pinion gears 11a and 11b are connected to the differential case 3 through the pinion shaft 12.

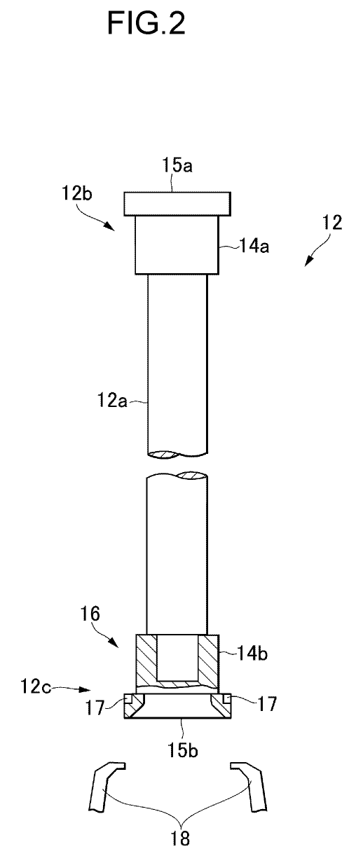

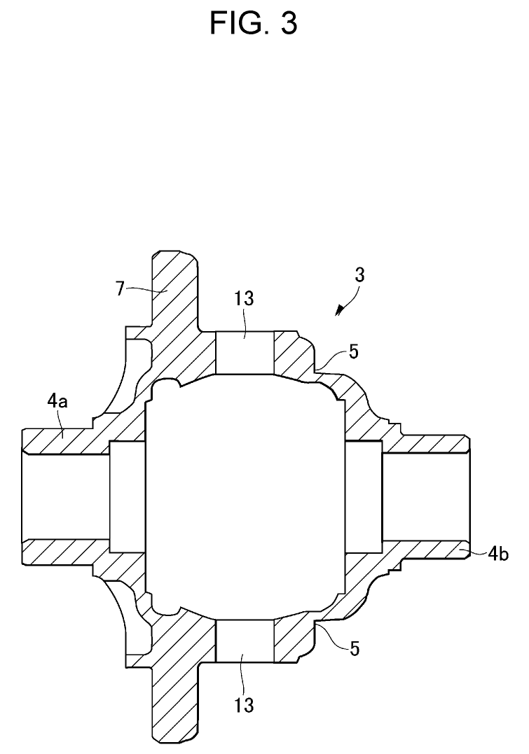

A structure of the pinion shaft 12 according to the exemplary embodiment of the present disclosure is shown in FIG. 2 in more detail, and a through hole 13 of the differential case 3 into which the pinion shaft 12 is inserted is shown in FIG. 3. The pinion shaft 12 is a rod member made of metal comprising an intermediate shank section 12a on which the pinion gears 11a and 11b are mounted, and end sections 12b and 12c formed on both sides of the intermediate shank section 12a. The end section 12b includes a plug portion 14a and an expanded portion 15a, and the end section 12c includes a plug portion 14b and an expanded portion 15b. As explained later, the plug portion 14a is press-fitted into one of the through holes 13 of the differential case 3, and the plug portion 14b is press-fitted into the other one of the through holes 13 of the differential case 3. Specifically, an outer diameter of each of the plug portions 14a and 14b is individually larger than an outer diameter of the intermediate shank section 12a, and each of the through holes 13 and each of the plug portions 14a and 14b has a circular cross-section perpendicular to a center axis thereof. Therefore, the plug portion 14a press-fitted into the through hole 13 is in close contact with the through hole 13 without space therebetween, and the plug portion 14b press-fitted into the through hole 13 is in close contact with the through hole 13 without space therebetween. For this reason, a wide pressure receiving area may be ensured between the through hole 13 and the plug portion 14a to receive a load acting therebetween. Likewise, a wide pressure receiving area may be ensured between the through hole 13 and the plug portion 14b to receive a load acting therebetween.

Expanded portions 15a and 15b are overhang portions located outside of the through holes 13 of the differential case 3, and outer diameters of the expanded portions 15a and 15b are larger than inner diameters of the through holes 13. In order to press-fit the pinion shaft 12 into the through hole 13, a pressing force or a load is applied to the expanded portion 15a or 15b. However, since the diameters of the expanded portions 15a and 15b are large, the pressing force or the load may be applied easily to the expanded portion 15a or 15b without deforming the expanded portion 15a or 15b and an edge of the expanded portion 15a or 15b. Therefore, the differential unit 1 may be assembled easily. For example, the expanded portions 15a and 15b may be formed on or attached to the plug portions 14a and 14b in the process of inserting the pinion shaft 12 into the differential case 3. Instead, the expanded portions 15a and 15b may also be attached to the plug portions 14a and 14b after inserting the pinion shaft 12 into the differential case 3.

In the pinion shaft 12 shown in FIG. 2, one of end sections 12c may be attached to and detached from the intermediate shank section 12a. As shown in FIG. 2, the end section 12c includes a plug member 16 in which the plug portion 14b and the expanded portion 15b are integrated. In this case, the plug portion 14b is formed into a hollow cylindrical shape, and the intermediate shank section 12a is press-fitted tightly into the hollow space of the plug portion 14b. In addition, an engagement portion 17 is formed on the outer periphery of the expanded portion 15b, and a tool 18 is engaged with the engagement portion 17 to extract the plug member 16 from the through hole 13. For example, the engagement portion 17 may be formed by partially cutting out an outer peripheral edge of the expanded portion 15b. Otherwise, the engagement portion 17 may also be formed by partially depressing the expanded portion 15b away from the outer surface of the differential case 3, or by forming a recess on a predetermined site of an outer peripheral surface of the expanded portion 15b. Since the engagement portion 17 is formed in the expanded portion 15b, the plug member 16 may be fitted easily onto the intermediate shank section 12a of the pinion shaft 12, and dismounted easily from the intermediate shank section 12a of the pinion shaft 12. That is, the differential unit 1 may be assembled and disassembled easily.

In the differential unit 1 according to the exemplary embodiment of the present disclosure, the differential case 3 and the gears 10a,10b,11a and 11b held therein are rotated entirely by the torque delivered to the ring gear 8. In the situation where the differential case 3 is rotated, the pinion shaft 12 penetrating through the differential case 3 is rotated about a longitudinal center thereof by the rotation of the differential case 3 so that the pinion gears 11a and 11b mounted on the pinion shaft 12 revolve around the rotational center axis of the differential case 3. In this situation, since the pinion gears 11a and 11b are meshed with the side gears 10a and 10b, the side gears 10a and 10b are rotated by the torques derived from the revolution of the pinion gears 11a and 11b. Therefore, when the pinion gears 11a and 11b rotate in this situation, the side gears 10a and 10b are rotated in a differential manner.

Thus, the torque is transmitted from the differential case 3 to the pinion gears 11a and 11b through the pinion shaft 12. Therefore, inner circumferential surfaces of the through holes 13 of the differential case 3 and the outer circumferential surfaces of the plug portions 14a and 14b of the pinion shaft 12 are subjected to loads while the torque is transmitted from the differential case 3 to the pinion gears 11a and 11b. In this situation, the load is received by the entire inner circumferential surfaces of the through holes 13 and the entire outer circumferential surfaces of the plug portion 14a and 14b. That is, pressure receiving surfaces are widened, and hence the wear of those pressure receiving surfaces may be reduced. In addition, the pinion shaft 12 is press fitted into the through holes 13 of the differential case 3 to be integrated firmly with the differential case 3 without space or slack thereby increasing the rigidity of the differential case 3. Therefore, misalignments and transmission errors between the pinion gear 11a and the side gear 10a and between the pinion gear 11b and the side gear 10b may be reduced. Consequently, gear noises of the side gears 10a and 10b and the pinion gears 11a and 11b may be reduced.

In addition, in the differential unit 1 according to the exemplary embodiment of the present disclosure, the expanded portions 15a and 15b are formed on both ends of the pinion shaft 12. That is, an inertial mass or an inertial moment of the differential case 3 is increased by masses of the expanded portions 15a and 15b. Therefore, the rotational runout of the differential case 3 may be reduced so that the differential case 3 is allowed to rotate smoothly and stably. For this reason, a transmission error and a gear noise of the ring gear 8 may be reduced.

It is to be noted that the present disclosure is not limited to the foregoing exemplary embodiment. For example, two or more pairs of the pinion gears may be arranged in the differential unit 1. In this case, a bifurcated pinion shaft or a cross-shaped pinion shaft may be employed.

What is claimed is:

1. A differential unit, comprising:
a differential case in which a ring gear is formed integrally on its outer circumferential surface;
a pair of side gears held in the differential case while being opposed to each other to rotate on a rotational center axis of the differential case;
a pair of pinion gears interposed between the side gears while being meshed with the side gears; and
a pinion shaft penetrating through the pinion gears in a direction perpendicular to the rotational center axis of the differential case so as to support the pinion gears in a rotatable manner,
wherein both end sections of the pinion shaft are supported by the differential case,
the differential case comprises a through hole into which the end section of the pinion shaft is inserted,
the end section of the pinion shaft is press-fitted into the through hole of the differential case,
the pinion shaft comprises an overhang portion located outside of the through hole of the differential case, and
a diameter of the overhang portion is larger than an inner diameter of the through hole.

2. The differential unit as claimed in claim 1,
wherein one of the end sections of the pinion shaft includes a plug member having a hollow cylindrical shape that is formed integrally with the overhang portion,
the pinion shaft is fitted into a hollow space of the plug member, and
the plug member is press-fitted into the through hole.

3. The differential unit as claimed in claim 1, wherein the through hole and the end section press-fitted into the trough hole have a circular cross-section.

4. The differential unit as claimed in claim 2, wherein the through hole and the end section press-fitted into the trough hole have a circular cross-section.

5. The differential unit as claimed in claim 2, wherein the overhang portion of the plug member comprises an engagement portion that is engaged with a tool for extracting the plug member from the through hole.

6. The differential unit as claimed in claim 4, wherein the overhang portion of the plug member comprises an engagement portion that is engaged with a tool for extracting the plug member from the through hole.
